(19) United States
(12) Patent Application Publication
(10) Pub. No.: US 2010/0128174 A1
(43) Pub. Date: May 27, 2010

(54) ATSC MOBILE RECEPTION THROUGH OPTIMAL PLACEMENT OF MOBILE SENSITIVE PACKETS

(75) Inventors: Timothy J. Talty, Beverly Hills, MI (US); Cem U. Saraydar, Royal Oak, MI (US); Andrew J. MacDonald, Grosse Pointe Park, MI (US); Michael B. Ames, Lake Orion, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/275,943

(22) Filed: Nov. 21, 2008

(51) Int. Cl. H04N 7/00

(52) U.S. Cl. 348/461; 348/E07.001

(57) ABSTRACT

A method for producing data frames by the optimal placement of mobile sensitive data packets in the data frame that has particular application for transmitting mobile data to be received by portable consumer electronics devices and/or moving vehicles. The method includes forming the data frame by inserting the mobile data in the data frame just after a frame sync and before the broadcast data.

### BACKGROUND OF THE INVENTION

1. Field of the Invention

This invention relates generally to a method for providing an advanced television standards committee (ATSC) data frame and, more particularly, to a method for positioning mobile data in an ATSC data frame.

2. Description of the Related Art

Conventional broadcasting of data, such as television transmission signals, typically uses analog signals. In North America television stations will be transitioning to a digital format where the television transmission signals will be typically produced and transmitted using an advanced television standards committee (ATSC) data frame protocol, well known to those skilled in the art. With the advent of digital data broadcasting techniques, the same amount of information to be broadcast requires less bandwidth as compared to broadcasting analog signals. Therefore, broadcasting of data using digital signals allows additional data to be broadcast in a given bandwidth while still delivering high quality programs. The additional data can be used for many applications, including alternative television programming and other data related services, including the transmission of weather information and traffic information and audio and video files. Further, the transition to digital television transmission enables new receiver technology. While this new receiver technology has been developed to deliver high quality service to stationary receivers, the present invention reveals how modifications can be made to the transmission system to enable reliable reception to mobile devices including consumer portable electronic devices and motor vehicles.

Data is generally transmitted in the form of multiple data frames. Each data frame transmitted to a non-moving receiver typically includes a frame sync portion and a data portion. The frame sync allows the receiver to lock onto the received signal so that the transmitted signal can be received and deciphered by the receiver. In one technique, the frame sync locks the receiver with the received signal by setting equalization coefficients in the receiver.

After a certain period of time, a non-moving receiver goes out of synchronization with the incoming signals. This happens as a result of data dispersion caused by multipath fading during signal propagation. Multipath fading causes errors that affect the quality of reception. The errors are due to intersymbol interference (ISI). ISI is a form of distortion of a signal in which one symbol interferes with subsequent symbols. This is an unwanted phenomenon as the previous symbols have a similar effect to noise, thus making the communication less reliable. Equalizers can be used to correct ISI. Hence, in the case of non-moving receivers, the receiver is locked with the received signals using the frame sync after every predefined interval of time for continuous reception of the data without any significant loss.

For a moving receiver, the data frame suffers additional dispersion caused by the doppler shift along with the distortion caused by ISI due to the multipath fading. Therefore, a receiver in a moving vehicle needs to resynchronize with the incoming data frames more frequently as compared to a stationary or non-moving receiver for successful reception of the data without any significant loss. However, due to the time interval between the transmission of the sync data, receivers in a moving vehicle are not able to adjust the equalizer coefficients as fast as desired, which causes loss of synchronization and loss of a significant portion of the data.

One existing method for overcoming this issue is to incorporate additional encoding into the television data stream including transmitting sync pulses more often. The ATSC standard committee is investigating these types of methods. A significant limitation of these techniques is that the additional encoding required consumes bandwidth that would otherwise be used for transmitting useful data. Some of these techniques reduce the available data throughput to be over 20%. Thus, the owner of the transmitter must remove data that was to be delivered in order to enable mobile reception.

A method proposed in this invention does not require additional encoding schemes to enable the delivery of data to mobile devices. Hence, all of the existing data services can be provided, including stationary and mobile devices.

### SUMMARY OF THE INVENTION

In accordance with the teachings of the present invention, a method for producing data frames is disclosed including the optimal placement of mobile sensitive data packets in the data frame that has particular application for transmitting mobile data to be received by portable consumer electronics devices and/or moving vehicles. The method includes forming the data frame by inserting the mobile data in the data frame just after a frame sync and before the broadcast data.

Additional features of the present invention will become apparent from the following description and appended claims, taken in conjunction with the accompanying drawings.

### BRIEF DESCRIPTION OF THE DRAWINGS

FIG. 1 is an illustration of an ATSC data frame; and

FIG. 2 is a block diagram of a system for providing ATSC data frames.

### DETAILED DESCRIPTION OF THE EMBODIMENTS

The following discussion of the embodiments of the invention directed to a system and method for providing optimal placement of mobile sensitive data packets in an ATCS data frame is merely exemplary in nature, and is in no way intended to limit the invention or its applications or uses.

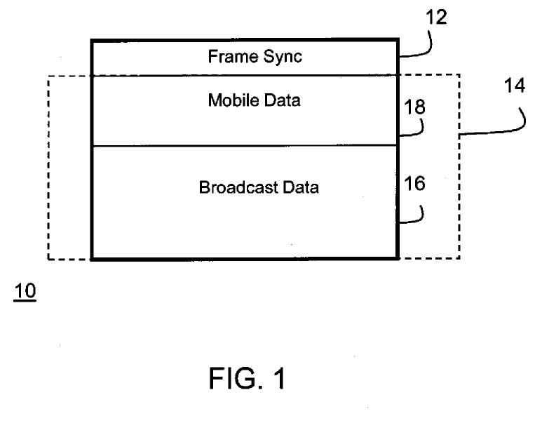

FIG. 1 is an illustration of an ATSC data frame 10. The data frame 10 can be transmitted or broadcast by a central station. Examples of suitable central stations include, but are not limited to, television stations, radio stations, etc. The ATSC data frame 10 includes a frame sync 12 and a data segment 14. The frame sync 12 synchronizes the data segment 14 with a receiver to allow the receiver to lock onto the received signal to accurately receive the ATSC data frame 10, as is well understood in the art. The data segment 14 includes broadcast data 16 and mobile data 18. The broadcast data 16 is meant to be received and used by a stationary receiver. Examples of broadcast data include, but are not limited to, audio data, video data, text data, and combinations thereof. The mobile data 18 is meant to be received and used by a moving receiver, such as a vehicle receiver or a portable consumer electronics device. Examples of mobile data include, but are not limited to, traffic information, weather information, vehicle service schedule, driver information, video and audio files, and any data of interest to a driver of a moving vehicle, any data of interest to passengers of the moving vehicle, any data of interest to people carrying portable electronic devices and combinations thereof.

The mobile data 18 is inserted into the ATSC data frame 10 just after the frame sync 12 as opposed to randomly dispersing the mobile data 18 in the data segment 14. By inserting the mobile data 18 just after the frame sync 12, the mobile data 18 is received within a coherence time of the receiver in the portable consumer electronics device and/or moving vehicle, thereby minimizing the dispersion losses in the received mobile data 18. Coherence time is defined as the time during which a receiver remains in synchronization with the incoming data as provided by the frame sync 12. In one non-limiting embodiment, the coherence time can be about 1.5 milliseconds for a moving receiver traveling at high speed, where the mobile data 18 is provided in the data frame 10 to be transmitted after the frame sync 12 within 1.5 milliseconds.

To aid in the understanding of the present invention, an exemplary scenario is provided. When an incoming data signal is received by a vehicle moving at a speed of 100 miles per hour (MPH), the doppler shift corresponding to the received data signal is 119 Hertz. A typical coherence time corresponding to the doppler shift of 119 Hz is 3.5 milliseconds. When updating the receiver at twice the data rate, the receiver needs to be synchronized every 1.7 milliseconds, which is every 19,000 symbols. The current ATSC technology standard cannot achieve synchronization beyond 300 symbols. Therefore, in order to effectively transmit the mobile data 18 to the vehicle moving at 100 MPH, the mobile data 18 is inserted just after the frame sync 12 and before the broadcast data 16, so that it is in the coherence time provided by the frame sync 12 to ensure quality reception of the mobile data 18 without any significant losses due to the movement of the vehicle.

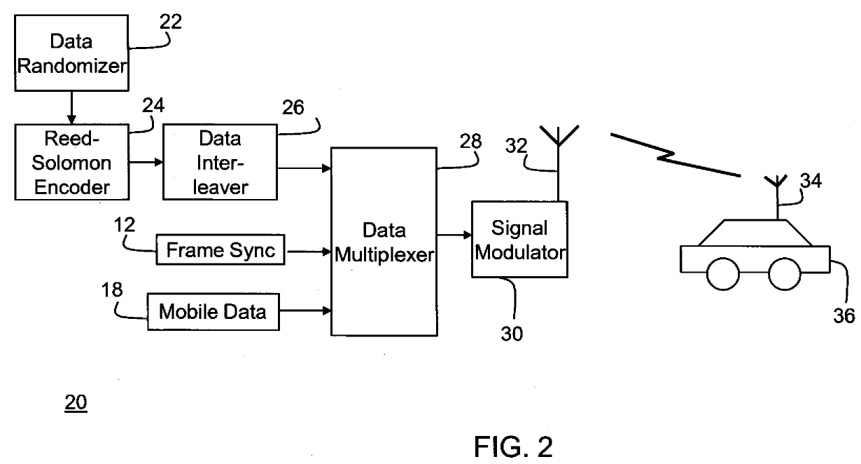

FIG. 2 is a block diagram of a transmission system 20 illustrating an exemplary implementation of the present invention. The broadcast data 16 is first processed by a data randomizer 22. The data randomizer 22 encrypts the broadcast data 16 by transposing or inverting the contents of the broadcast data 16. The output signal from the data randomizer 22 is further processed by a Reed-Solomon encoder 24. The Reed-Solomon encoder 24 generates a polynomial based on the broadcast data 16 to regenerate the part of the broadcast data 16 that might be lost during transmission to the receiver. Further, the output signal from the Reed-Solomon encoder 24 is processed by a data interleaver 26. Interleaving is a known technique by which encoded digital data is reordered before transmission in such a manner that any two successive digital data bits in the original data stream are separated by a predetermined distance in the transmitted data stream. The data interleaver 26 interleaves the broadcast data 16 so that if there is a burst error during transmission, the broadcast data 16 can be retrieved successfully by the receiver.

The output signal from the data interleaver 26, the frame sync 12 and the mobile data 18 are provided to a data multiplexer 28. The mobile data 18 is directly fed to the data multiplexer 28 to prevent spreading of the mobile data 18 across the entire bandwidth of the data segment 14, which otherwise can cause loss of data due to dispersion when the ATSC data frame 10 is transmitted to the portable consumer electronics device and/or moving vehicle, as discussed above. The data multiplexer 28 multiplexes the output signal from the data interleaver 26, the frame sync 12 and the mobile data 18 for transmission of the ATSC data frame 10.

The ATSC data frame 10 from the data multiplexer 28 is processed by a signal modulator 30. The signal modulator 30 modulates the ATSC data frame 10 onto a carrier signal. An antenna 32 transmits the modulated signal to be received by a receiver 34 of a moving vehicle 36 or a portable consumer electronics device.

Various embodiments of the present invention offer one or more advantages. The present invention provides a method for effectively transmitting ATSC data frames to a portable consumer electronics device and/or moving vehicles. The method of the present invention comprises the insertion of mobile data just after the frame sync in an ATSC data frame so that when the ATSC data frame is received by the portable consumer electronics device and/or moving vehicle there is no loss of mobile data due to dispersion caused by the doppler shift. Further, the method provides an adequate and effective way of transmitting the data to the portable consumer electronics device and/or moving vehicle without any substantial loss of the data.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for transmitting broadcast data frames, said method comprising:
forming the data frame to include mobile data to be received by a moving receiver and broadcast data to be received by a non-moving receiver, wherein the mobile data is inserted between a frame sync and the broadcast data in the data frame; and
transmitting the data frame to the moving receiver.

2. The method according to claim 1 wherein the moving receiver is on a vehicle or a portable consumer electronics device.

3. The method according to claim 2 wherein the mobile data is selected from the group comprising traffic information, weather information, driver information, video, audio and file transmissions.

4. The method according to claim 1 wherein forming the data frame includes processing the broadcast data using a data randomizer, a Reed-Solomon encoder and a data interleaver, and multiplexing the frame sync, the broadcast data and the mobile data using a data multiplexer.

5. The method according to claim 1 wherein the data frame is an advanced television standards committee (ATSC) compliant data frame.

6. The method according to claim 5 wherein the ATSC compliant data frame is transmitted using an ATSC digital television system.

7. The method according to claim 1 wherein the mobile data is placed within the data frame so that it is transmitted within 1.5 milliseconds of the frame sync.

8. An advanced television standards committee (ATSC) data frame, said ATSC data frame comprising:
broadcast data;
a frame sync; and
mobile data, wherein the mobile data is inserted between the frame sync and the broadcast data in the data frame.

9. The ATSC data frame according to claim 8 wherein the data frame is received by a receiver on a vehicle or a portable consumer electronics device.

10. The ATSC data frame according to claim 9 wherein the mobile data is selected from a group comprising traffic information, weather information, driver information, video, audio and file transmissions.

11. The ATSC data frame according to claim 8 wherein the ATSC data frame is formed by processing the broadcast data using a data randomizer, a Reed-Solomon encoder and a data interleaver, and multiplexing the frame sync, the broadcast data and the mobile data by a data multiplexer.

12. The ATSC data frame according to claim 8 wherein the ATSC data frame is transmitted by an ATSC digital television system.

13. A system for transmitting a data frame, said system comprising:
a data multiplexer that multiplexes broadcast data, a frame sync and mobile data to form the data frame, wherein the mobile data is placed between the frame sync and the broadcast data in the data frame;
a signal modulator for modulating the data frame onto a carrier signal; and
an antenna for transmitting the modulated data frame to a moving receiver and non-moving receiver.

14. The system according to claim 13 further comprising a data randomizer, wherein the data randomizer processes the broadcast data before the broadcast data is input into the data multiplexer.

15. The system according to claim 13 further comprising a Reed-Solomon encoder, wherein the Reed-Solomon encoder processes the broadcast data before the broadcast data is input into the data multiplexer.

16. The system according to claim 13 further comprising a data interleaver that interleaves the broadcast data before the broadcast data is input into the data multiplexer.

17. The system according to claim 13 wherein the data frame is an advanced television standards committee (ATSC) data frame.

18. The system according to claim 13 wherein the moving receiver is on a vehicle or a portable consumer electronics device.

19. The system according to claim 18 wherein the mobile data is selected from a group comprising traffic information, weather information, driver information, video, audio and file transmissions.

20. The system according to claim 13 wherein the mobile data is placed within the data frame so that it is transmitted within 1.5 milliseconds of the frame sync.
